(19) United States
(12) Patent Application Publication
(10) Pub. No.: US 2025/0260613 A1
(43) Pub. Date: Aug. 14, 2025

(54) DYNAMIC RESILIENT LINKS

(71) Applicant: Samsung Electronics Co., Ltd., Suwon-si (KR)

(72) Inventors: Bruce Gregory Warren, Poulsbo, WA (US); Rohit Bhatia, Fort Collins, CO (US)

(21) Appl. No.: 18/830,233

(22) Filed: Sep. 10, 2024

Related U.S. Application Data
(60) Provisional application No. 63/553,493, filed on Feb. 14, 2024.

(51) Int. Cl. H04L 41/0654

(52) U.S. Cl. CPC H04L 41/0654

(57) ABSTRACT

A computer system includes two or more devices connected to each other. Each of the devices includes a switch core, port logic elements connected to the switch core that each include a transmit replay buffer and receive logic, and physical layers connected to the port logic elements. In response to a link failure between a first port logic element of a first device and a second device, the first port logic element enters a loopback mode. In the loopback mode, an in-flight data packet including acknowledged data segments and unacknowledged data segments is looped back from the transmit replay buffer and the port receive logic of the first port logic element to the switch core, and from the switch core to a second port logic element to avoid loss of in-flight data.

### CROSS-REFERENCE TO RELATED APPLICATION(S)

The present application claims priority to and the benefit of U.S. Provisional Application No. 63/553,493, filed Feb. 14, 2024, the entire content of which is incorporated herein by reference.

### BACKGROUND

### 1. Field

The present disclosure relates to high-speed computer networks.

### 2. Description of the Related Art

High-speed computer networks depend on reliable interconnect mechanisms to move data without corruption. Large supercomputer systems connect a large number of compute endpoints via a network assembled with a large number of switches and links between themselves and the compute endpoints. There could be hundreds of thousands or more high-speed network links which are subject to both intermittent and hard failures in such supercomputer systems. Such link failures pose a significant challenge to keeping large supercomputer systems up, available, and running applications.

In the related art, soft link failures may be mitigated by mechanisms that correct transmitted frames (e.g., forward error correction (FEC)) or retransmit the frames (e.g., go-back-n, selective acknowledgement (ACK), link-level-replay, etc.). For instance, in related art networks, such as Ethernet, FEC code is utilized in conjunction with end-to-end mechanisms, such as go-back-n or selective ACK, to ensure data delivery. Other related art networks, such as PCIe, utilize point-to-point replay and error detection (or error detection coupled with a light-weight FEC) to achieve an effective Bit Error Rate (BER) approaching zero. However, although these related art mechanisms may work well under normal operating conditions, failures due to hardware issues, such as failed devices or cables, can cause a link to fail and become unavailable, resulting in lost data and degraded system availability.

Additionally, in the related art, hard link failures (e.g., due to failed devices, cables, etc.), which results in entire packets being lost, may be mitigated by retransmitting data via an alternate path to route data around the failed link, or performing a software fallback to a checkpoint, reconfiguring the system to exclude failed components, and restarting from the checkpoint. For instance, related art High Performance Computing (HPC) systems utilize either end-to-end retries for intermittent failures or checkpoint restarts for hard failures. End-to-end retries result in network bandwidth wastage and degrade tail latency affecting time to solution for applications. Checkpoints, wherein the system goes back to a known state and restarts processing upon corruption/loss of data, also degrades system availability and increases software overhead/processing delays associated with a restart.

In the related art, increased reliability has a cost in the form of non-trivial performance implications. For instance, non-posted traffic (in which the requester expects to receive a completion Transaction Layer Packet (TLP) from the device completing the request, such as memory reads) results in timeouts at the source waiting on a response, and posted traffic (in which the requester does not expect and will not receive a completion TLP from the device completing the request, such as memory writes) may result in timeouts at the destination detecting incomplete data delivery or incorrect results if the device completing the request does not detect missing data.

The above information disclosed in this Background section is only for enhancement of understanding of the background of the invention and therefore it may contain information that does not constitute prior art.

### SUMMARY

The present disclosure relates to various embodiments of computer system configured to automatically reroute data traffic in response to a failed link between two devices. In this manner, data that would be lost in related art devices loops back locally and is retransmitted (replayed) to the other device via an alternate path.

In one embodiment, the computer system includes two or more devices connected to each other and each of these devices includes a switch core, two or more port logic elements connected to the switch core that each include a transmit replay buffer and receive logic, and physical layers connected to the port logic elements. In response to a link failure between a first port logic element of a first device and a second device, the first port logic element enters a loopback mode. In the loopback mode, an in-flight data packet including acknowledged data segments and unacknowledged data segments is looped back from the transmit replay buffer and the port receive logic of the first port logic element to the switch core, and from the switch core to a second port logic element.

The link between the first device and the second device may be restored by a physical layer of the second port logic element.

The second device, in response to the link failure, may be configured to mark and discard partially received data from the first device.

The first device, in response to the link failure, may be configured to replay the incompletely transmitted data packets to the second device.

The second device may be configured to discard the replayed data until the second device detects a start-of-packet.

In the loopback mode, the first device may be configured to replay the incompletely transmitted data packets (including both acknowledged and unacknowledged packet segments) until the transmit replay buffer of the first port logic element is drained.

In the loopback mode, the first device may be configured to temporarily pause transmission of data to the first port logic element.

The computer system may be configured to determine a data packet type of the data.

The first device may be configured to replay the data in response to the data packet type being a first data packet type.

The first device may be configured not to replay the data in response to the data packet type being a second data packet type different than the first data packet type. The computer system may be configured to determine a link type between the first device and the second device.

The first device may be configured to replay the data in response to link type being a first link type.

The first device may be configured not to replay the data in response to the link type being a second link type different than the first link type.

The computer system may include a watchdog timer.

In another embodiment, the computer system includes two or more boards connected to each other in which each board includes compute elements and switches connected to the compute elements. In response to a link failure between one switch of a first board and one switch of a second board, the one switch of the first board enters a loopback mode. In the loopback mode, an in-flight data packet including acknowledged data segments and unacknowledged data segments is looped back in the one switch of the first board and is rerouted to one switch of a third board, and from the one switch of the third board to the one switch of the second board. In one or more embodiments, in the loopback mode, the pending transmit data may be looped back in the one switch of the first board and rerouted to one switch of a second board, and from the one switch of the second board to another switch of the second board.

In one embodiment, a computer board includes switches and compute elements connected to the switches. In response to a link failure between a first compute element and a first switch, the first switch enters a loopback mode. In the loopback mode, an in-flight data packet including acknowledged data segments an unacknowledged data segments is looped back in the first switch and rerouted to a second compute element, and from the second compute element to a second switch, and from the second switch to the first compute element.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable method or system.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIG. 1A is a schematic view depicting a port operating in a loopback mode between a transmit replay buffer and receive logic according to one embodiment of the present disclosure;

FIG. 1B is a schematic view depicting a transmit replay buffer according to one embodiment of the present disclosure;

FIG. 2 is a schematic view depicting dynamic resiliency between two endpoints across different collections of compute nodes and switches (different boards) according to one embodiment of the present disclosure; and

FIG. 3 is a schematic view depicting dynamic resiliency between two endpoints in the collection of compute nodes and switches (same board) according to one embodiment of the present disclosure.

### DETAILED DESCRIPTION

The present disclosure relates to various embodiments of computer systems and methods of rerouting data packets transmitted between a first computing device and a second computing device in response to a link failure (e.g., due to excessive bit error rate (BER) or link removal) between the two devices. The computer systems of the present disclosure include characteristics of both link-level replay and alternate routing paths between endpoints to dynamically and automatically recover from failed links without traffic interruption between the endpoints. The computer systems of the present disclosure are configured to place the failed link into a loopback mode, reflect or redirect the data packets back arriving at the failed link into the switch core, and re-route the reflected data to an alternate port such that the data is received at the intended endpoint. This dynamic automatic recovery eliminates (or at least reduces) the occurrence of lost data and increases system availability, which otherwise requires checkpoint restarts of the system. Additionally, in one or more embodiments, the computer systems of the present disclosure utilize a hardware mechanism to place the failed link into a loopback mode, and thus it occurs in near real-time, as opposed to related art solutions that generally require some amount of software to detect and provide alleviation. In one or more embodiments, the computer system may also be configured to utilize a tag field check to determine and discard duplicate data packets that are transmitted as a result of replaying data in response to the failed link. Unlike related art systems and methods in which only the unacknowledged data segments are looped back and thus the acknowledged segments are lost, the systems and methods of the present disclosure are configured to re-route and replay an entire in-flight data packet (including both acknowledged data segments and unacknowledged data segments) such that no data is lost.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

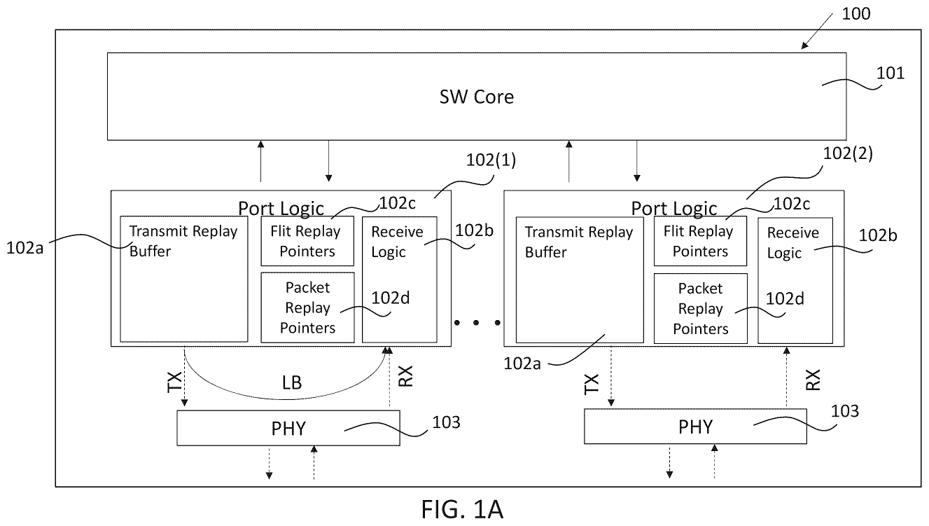

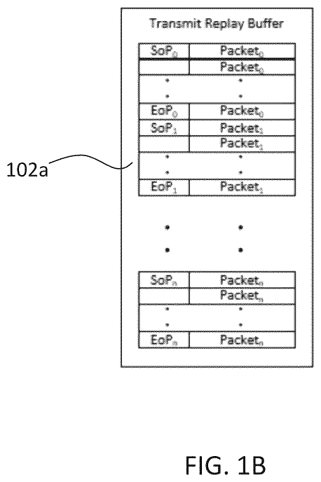

FIG. 1A depicts a device 100 (e.g., a switch or networking device) of a computer system (e.g., a Peripheral Component Interconnect Express (PCIe) system) according to one embodiment of the present disclosure. In the illustrated embodiment, the device 100 includes a switch core (SW core) 101, a plurality of port logic elements 102 connected to the core 101, and a plurality of physical layers (“PHY”) 103 connected to the plurality of port logic elements 102 (i.e., each PHY 103 is connected to a corresponding one of the port logic elements 102). Each of the port logic elements 102 includes a transmit replay buffer 102a, a receive logic 102b, flit replay pointers 102c, and packet replay pointers 102d. The transmit replay buffer 102a stores data packets (e.g., transaction layer packets (TLPs), frames, and/or flits) with a unique sequence number and other information (e.g., LCRC fields). The transmit replay buffer 102a is configured to purge the stored data packets in response to receipt of an ACK DLLP indicating that the data packets reached the receiver of another device successfully, and is configured to replay (i.e., re-transmit) the data packets stored in the transmit replay buffer 102a in response to receipt, by the receive logic 102b, of a NAK DLLP indicating that the data packets did not reach the receiver successfully.

In response to a failed link between the device 100 and another computing device, the link between the two computing devices is marked as “down” and the device 100 is configured to enter a “loopback mode” whereby an entire data packet (which may include both acknowledged data segments and unacknowledged data segments) is looped back (arrow “LB”) between the transmit replay buffer 102a and the port receive logic 102b of the port logic element 102 (1) that corresponds to the failed link, and the transmit data is rerouted through the switch core 101 to another one of the port logic elements 102 (2) to maintain a link with the other computing device (i.e., in response to a failed link, the switch core 101 is configured to utilize a different port logic element 102 to reroute the data and thereby maintain the link to the other computing device). That is, in the loopback mode, the transmit data of the failed link is rerouted back through the switch core to seek an alternate route through another active port logic element to the original endpoint (i.e., the alternate route utilizes an already established alive link to transmit the data to the endpoint). In one or more embodiments, only the individual port logic element 102 associated with the failed link (not the remainder of the port logic elements 102 of the device 100) is configured to enter the “loopback mode.” Additionally, in one or more embodiments, in response to a failed link between the device 100 and another computing device, the device 100 is configured to replay (i.e., re-transmit) a sufficient amount of data (e.g., a sufficient number of TLPs, frames, and/or flits) such that the linked computing device receives all of the requested data. In one or more embodiments, the device 100 may receive an ACK in response to receipt of only a portion of the transmitted data, and thus the device 100 may replay the transmit data that has previously been acknowledged (in addition to the data that was non acknowledged) to ensure the entire packet(s) that were in-flight at the time of link failure are looped back. In one or more embodiments, the flit replay pointers 102c are configured to replay NACK′ed and/or unacknowledged packet segments (flits) and the buffer replay pointers 102d are configured to replay packet segments that have been ACK′ed for a packet that hasn't fully being ACK′ed before the link failed. For instance, in one or more embodiments, the device 100 is configured to loop the data between the transmit replay buffer 102a and the port receive logic 102b until the transmit replay buffer 102a is drained (i.e., there is no transmit data stored in the transmit replay buffer 102a). For instance, as illustrated in FIG. 1B, in one or more embodiments in which a data packet is broken into 10 segments in which 7 segments have been acknowledged and 3 segments have not been transmitted and/or not acknowledged, the device 100 is configured to loop back the 7 acknowledged data segments and the 3 unacknowledged data segments in the transmit replay buffer 102a such that no data is lost (i.e., the entire data packet is replayed). In contrast, in the related art, only the unacknowledged data segments are looped back and thus the acknowledged segments are lost. Additionally, the lost segments will require the endpoints involved to execute some form of error recovery (e.g., a timeout) and the originator will have to retransmit the lost data, and thus this error recovery will cause significant tail latency.

In one or more embodiments, in response to a failed link between the device 100 and another computing device, the switch core 101 is configured to temporarily pause at least some data traffic (i.e., some or all data traffic) until the data destined for the original port is drained from the transmit replay buffer 102a to maintain proper ordering of the data. In one or more embodiments, the pause may be just for traffic destined for the port logic element 102 with the failed link. Additionally, in one or more embodiments, the pause may include a programmable delay (e.g., approximately tens of microseconds) to account for potential delays on the original path due to congestion and/or longer path delays. Additionally, in one or more embodiments, the device 100 may include a watchdog timer configured to monitor for issues. The watchdog timer may be configured to detect a link failure event and to leave cleanup to higher level network management outside of the switch core 101.

Following the rerouting of the data from the port logic element 102 (1) with the failed link through the switch core 101 to another one of the port logic elements 102 (2) to establish a link with the other computing device, the data (e.g., the TLPs/frames) is transmitted from the PHY 103 associated with the port logic element 102 (2). The TLPs/frames received by the other computing device have their tags checked against expected tags. In response to a duplicate tag being received, the duplicate TLP/frame is discarded. Accordingly, once the data is replayed from the device 100, the other computing device will receive only one of each TLP/frame (i.e., the computing device will discard the received TLPs/frames and therefore not receive duplicate copies of any TLPs/frames after the data is retransmitted from the device 100). In one or more embodiments, the receiver of the computing device, upon receiving replayed data, is configured to discard data until it detects a start-of-packet so only complete TLPs/frames are forwarded onward.

As described above, the device 100 utilizes link-level-replay architecture to determine any packets that may have segments that are unacknowledged that may be in flight and to replay and re-route traffic through an alternate port without any data loss (i.e., the device 100 includes a mechanism to loop data packets at the port level to re-route traffic around a failed link without software assistance, and thereby prevent lost traffic due to a surprise unplug/hard link failure). In this manner, the device 100 improves network reliability such that reliance on non-posted transactions (i.e., transactions in which the requester expects to receive a completion Transaction Layer Packet (TLP) from the device completing the request) may be reduced. Accordingly, the higher confidence in network reliability leads to different architectural tradeoffs between the mix of posted- and non-posted traffic. The device 100 also reduces timeouts or other errors (e.g., fatal or non-fatal errors) due to packet loss because unacknowledged data segments are recoverable and no data is lost, which results in increased system uptime. Furthermore, the device 100 may be configured to track sequence numbers of the data packets received by the second device such that duplicated packets may be discarded. In one or more embodiments, the device 100 may track data packets at the flit and packet level for proper replay and it may discriminate between data packets that may be replayed and those that may not be replayed. The device 100 may also track link types between the devices to determine if data replay is appropriate. For instance, inter-switch links (ISL) may be suitable for replay if an alternate path exists, and endpoint links may not be suitable for replay because an alternate path may not exist.

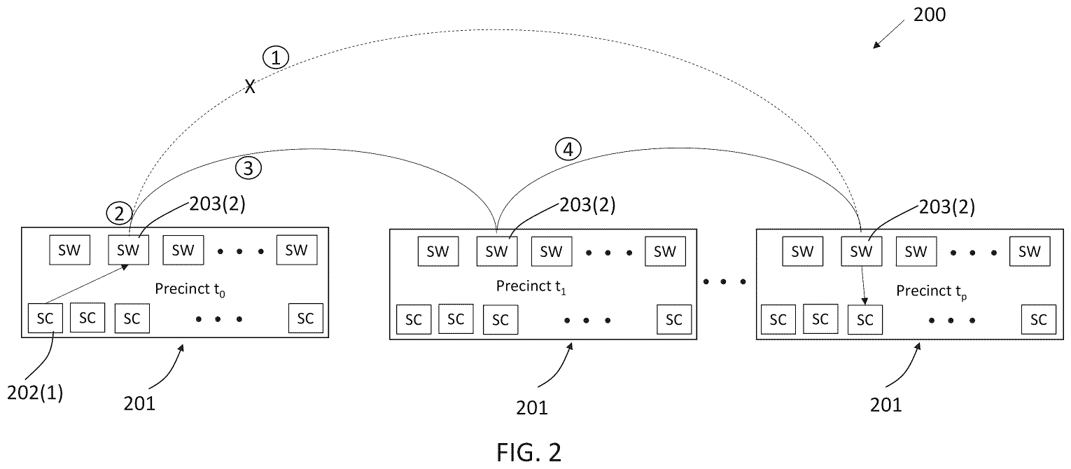

FIG. 2 depicts a computer system 200 according to one embodiment of the present disclosure including a plurality of precincts or boards 201 (e.g., boards t₀, t₁, and tₚ) connected to each other. Each board 201 includes a plurality of compute nodes 202 connected to a plurality of switches 203.

In the illustrated embodiment, the link between one of the switches 203 (e.g., the second switch 203(2)) in the first board 201 (t₀) and one of the switches 203 (e.g., the second switch 203(2)) in the last board 201 (tₚ) has failed. In response to the failed link, the switch 203(2) of the first board 201 (t₀) is placed in a loopback (as described above with reference to FIG. 1A) and the data packets destined for the last board 201 (tₚ) are rerouted. That is, an entire data packet (which may include acknowledged data segments and unacknowledged data segments) is looped back between the transmit replay buffer and the port receive logic of the port logic element that corresponds to the failed link, and the transmit data is rerouted through a switch core to another one of the port logic elements to establish a link with one of the other boards 201. In the illustrated embodiment, the data packets are rerouted from the switch 203 of the first board 201 (t₀) that is operating in the loopback mode to one of the switches 203 of the second board 201 (t₁), and then the data is forwarded by the switch 203 (e.g., switch 203(2)) of the second board 201 (t₁) to the intended switch 203 (e.g., switch 203(2)) in the last board 201 (tₚ). In this manner, the computer system 200 utilizes adaptive routing to select an alternate path to restore a failed link between two boards 201. Although in the illustrated embodiment the in-flight data packet (including the acknowledged data segments and the unacknowledged data segments) is re-routed from the first board to the third board and then to the second board, in one or more embodiments, the in-flight data packet (which is intended for the second switch 203(2) of the second board 201), may be re-routed to another switch (e.g., switch 203(1) of the second board) and then to the intended second switch 203(2)). That is, in one or more embodiments, in the loopback mode, the in-flight data packet (including the acknowledged data segments and the unacknowledged data segments) may be looped back in one switch of the first board and then rerouted to one switch of the second board, and from that switch of the second board to another switch of the second board, which is the intended destination of the data packet.

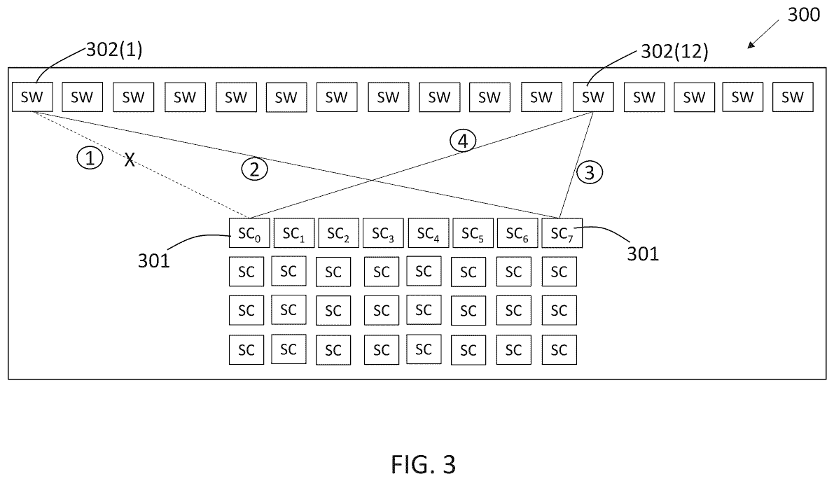

FIG. 3 depicts a board 300 according to one embodiment of the present disclosure. In the illustrated embodiment, the board 300 includes a plurality of compute elements 301 (e.g., an array of compute elements, including eight compute elements SC₀ to SC₇ in each of four rows) connected to a plurality of switches 302.

In response to a link between one of the compute elements 301 and one of the switches 302 being broken, the board 300 is configured to enter loopback mode and reroute the data packets. In the illustrated embodiment, the link between a first compute element 301 SC₀ and the first switch 302(1) is broken (as indicated by the dashed line and the “x”). In response to this broken link, the switch 302(1) is placed in a loopback (as described above with reference to FIG. 1A) and the data packets destined for the first compute element 301 SC₀ are rerouted. That is, the entire in-flight data packet (including the acknowledged data segments and the unacknowledged data segments) is looped back between the transmit replay buffer and the port receive logic of the port logic element that corresponds to the failed link, and the transmit data is rerouted through a switch core to another one of the port logic elements to establish a link with the compute element 301 SC₀. In the illustrated embodiment, in response to the link between the first compute element 301 SC₀ and the first switch 302(1) being broken, the board 300 is configured to reroute the data to the seventh compute element 301(7) (SC₇) and the port logic of the seventh compute element 301(7) (SC₇) is configured to route the data to a different switch (e.g., the twelfth switch 302(12)), which then routes the data to the first compute element 301 SC₀. In this manner, the board 300 has intra-board dynamic link resiliency to effectively restore the broken link between the first compute element 301 SC₀ and the first switch 302(1). In one or more embodiments, the mechanism utilized by the seventh compute element 301(7) to send the packet to the twelfth switch 302(12) to deliver it to the first compute element 301 may be “misroute reflection.” The misroute reflection mechanism includes logic to decode that a packet has arrived whose destination ID does not match any destination IDs on receiving compute element (e.g., the seventh compute element 301(7)). In one or more embodiments, the compute element (e.g., the seventh compute element 301(7)) may reflect the packet at least once to determine if the packet can be delivered to the intended first compute element 301. Reflecting the packet at least once may be implemented through a flag/field marked as such in the packet header and if such a marked packet is misrouted again it may be dropped (i.e., discarded).

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A computer system comprising:
a plurality of devices connected to each other, each of the plurality of devices comprising:
a switch core;
a plurality of port logic elements connected to the switch core, each of the plurality of port logic elements comprising a transmit replay buffer and receive logic; and
a plurality of physical layers connected to the plurality of port logic elements,
wherein, in response to a link failure between a first port logic element of a first device of the plurality of devices and a second device of the plurality of devices, the first port logic element enters a loopback mode;
wherein, in the loopback mode, an in-flight data packet comprising acknowledged data segments and unacknowledged data segments is looped back from the transmit replay buffer and the receive logic of the first port logic element to the switch core, and from the switch core to a second port logic element of the plurality of port logic elements.

2. The computer system of claim 1, wherein the link between the first device and the second device is restored by a physical layer of the second port logic element.

3. The computer system of claim 1, wherein the second device, in response to the link failure, is configured to mark and discard the acknowledged data segments from the first device.

4. The computer system of claim 1, wherein the first device, in response to the link failure, is configured to replay the incompletely transmitted data segments to the second device.

5. The computer system of claim 4, wherein the second device is configured to discard the replayed data until the second device detects a start-of-packet.

6. The computer system of claim 4, wherein, in the loopback mode, the first device is configured to replay the incompletely transmitted data packets until the transmit replay buffer of the first port logic element is drained.

7. The computer system of claim 4, wherein, in the loopback mode, the first device is configured to temporarily pause transmission of data to the first port logic element.

8. The computer system of claim 4, wherein the computer system is configured to determine a data packet type of the in-flight data packet.

9. The computer system of claim 8, wherein the first device is configured to replay the in-flight data packet in response to the data packet type being a first data packet type.

10. The computer system of claim 9, wherein the first device is configured not to replay the in-flight data packet in response to the data packet type being a second data packet type different than the first data packet type.

11. The computer system of claim 4, wherein the computer system is further configured to determine a link type between the first device and the second device.

12. The computer system of claim 11, wherein the first device is configured to replay the data in response to link type being a first link type.

13. The computer system of claim 12, wherein the first device is configured not to replay the data in response to the link type being a second link type different than the first link type.

14. The computer system of claim 1, further comprising a watchdog timer.

15. A computer system comprising:
a plurality of boards connected to each other, each of the plurality of boards comprising:
a plurality of compute elements; and
a plurality of switches connected to the plurality of compute elements,
wherein, in response to a link failure between one switch of the plurality of switches of a first board of the plurality of boards and one switch of the plurality of switches of a second board of the plurality of boards, the one switch of the first board enters a loopback mode, and
wherein, in the loopback mode, an in-flight data packet comprising acknowledged data segments and unacknowledged data segments is looped back in the one switch of the first board and rerouted to one switch of the plurality of switches of a third board of the plurality of boards, and from the one switch of the third board to the one switch of the second board, or to another switch of the plurality of switches of the second board and from the another switch of the second board to the one switch of the second board.

16. A computer board comprising:
a plurality of switches; and
a plurality of compute elements connected to the plurality of switches,
wherein, in response to a link failure between a first compute element of the plurality of compute elements and a first switch of the plurality of switches, the first switch enters a loopback mode, and
wherein, in the loopback mode, an in-flight data packet comprising acknowledged data segments and unacknowledged data segments is looped back in the first switch and rerouted to a second compute element of the plurality of compute elements, and from the second compute element to a second switch of the plurality of switches, and from the second switch to the first compute element.
